(19) United States
(12) Patent Application Publication
(10) Pub. No.: US 2020/0039163 A1
(43) Pub. Date: Feb. 6, 2020

(54) DEVICE FOR COLLECTING COMPACTION MATERIAL AND FOR FEEDING THE COLLECTED COMPACTION MATERIAL TO A PRESS THAT COMPACTS THE COMPACTION MATERIAL, AND MOBILE COLLECTION CART FOR USE IN THE DEVICE

(71) Applicant: STRAUTMANN GÉPGYÁRTÓ HUNGÁRIA KFT, Mátranovák (HU)

(72) Inventors: Wolfgang STRAUTMANN, Bad Laer (DE); Phillipp STRAUTMANN, Osnabrück (DE); Dominik STRAUTMANN, Bad Laer (DE)

(21) Appl. No.: 16/604,214

(22) PCT Filed: Apr. 23, 2018
(86) PCT No.: PCT/EP2018/060292

§ 371 Date: Oct. 21, 2019

(30) Foreign Application Priority Data
Apr. 24, 2017 (DE) 10 2017 108 631.5

(51) Int. Cl. B30B 9/30; B62B 3/00; B62B 3/04; B65F 1/12

(52) U.S. Cl. CPC B30B 9/301; B62B 3/002; B62B 2202/20; B65F 1/12; B62B 3/04

(57) ABSTRACT

A device for collecting and feeding compaction material to a press, comprising a collection cart having a compaction material collection compartment, and a compaction material feed device, with which the cart can be docked. The cart has a floor and opposing side walls and the compaction material can be removed, by an upward lifting motion, from the cart by the feed device and then fed to the press. A web-type, flexible or articulated carrier element with a floor portion and at least two opposing wall portions, each having an upper free edge, is provided on or in the cart. The carrier element, in an initial position, has a U-shaped form running parallel to at least two opposing side walls and the floor of the cart, when the cart is docked with the feed device. The carrier element can be shortened or lifted at one of the free edges.

### CROSS-REFERENCES TO RELATED APPLICATIONS

This application claims the benefit of the International Application No. PCT/EP2018/060292, filed on Apr. 23, 2018, and of the German patent application No. 10 2017 108 631.5 filed on Apr. 24, 2017, the entire disclosures of which are incorporated herein by way of reference.

### FIELD OF THE INVENTION

The present invention relates to a device for collecting compaction material and for feeding the collected compaction material to a press that compacts the compaction material, having at least one movable collection cart that has a collection compartment for compaction material to be compacted, and having a compaction material feed device to which the collection cart can be docked, the collection cart having a floor and a system of wheels on its underside, as well as at least two side walls situated opposite one another, and the compaction material that is to be compacted being removable from the collection cart by the compaction material feed device by being lifted upward, the material being capable of being supplied to a compaction compartment or compaction material reservoir of the press.

Moreover, the present invention relates to a movable collection cart for use in the above-indicated device, or also, for example, to a compaction container.

### BACKGROUND OF THE INVENTION

A device of the type named above is known from DE 10 2009 047 297 A1.

This document indicates a press having a collection cart that can be coupled and decoupled to it for compaction material to be compacted, the press having a compaction compartment, the collection cart having a collection compartment having a floor and walls, such that, when the collection cart is coupled to the press, compaction material collected in the cart can be transferred by machine from the collection cart into the compaction compartment, and when the collection cart is decoupled from the press, the cart can be filled with compaction material to be compacted at a location remote from the press. In order to empty the collection cart, at least the floor of the cart can be moved upward and back again from a lowered collection position. In addition, a compaction material feed device is provided with which, when the collection cart is coupled to the press, the compaction material situated in the collection compartment can be removed from the top, by moving at least the floor of the cart upward, and the material can be fed to the compaction compartment of the press. At the collection cart, a lifting device is provided by which at least the floor of the collection cart can be raised and lowered. Here, the floor of the collection cart can be capable of being raised and lowered by itself relative to the rest of the collection cart. Alternatively, the floor can be connected to a rear wall of the collection cart that is oriented away from the press when the cart is coupled to the press, so as to form an L-shaped floor-wall element, and the floor-wall element can be capable of being raised and lowered relative to the rest of the collection cart.

A development of the device according to the existing art cited above is described in DE 10 2010 000 938 A1. This document indicates a press having a collection cart and a compaction material feed device, in which a lifting device, for lifting at least the floor of the collection cart, is formed by at least one gear that can be driven rotationally and is situated on the press or on the compaction material feed device, said gear coming into engagement with at least one gear rod when the collection cart is coupled to the press, said rod being connected to the part of the collection cart that can be raised and lowered.

In the known devices, it is regarded as disadvantageous that the lifting device situated on the collection cart and/or on the compaction material feed device, for lifting the compacted material in the collection compartment of the collection cart, is technically very complicated, causing a disadvantageous heavy weight of the collection cart, which generally has to be moved manually, and contributing to high production costs of the device.

### SUMMARY OF THE INVENTION

Therefore, the present invention has an object of providing a device of the type named above in which the lifting device situated on the collection cart and/or on the compaction material feed device, for lifting the compaction material in the collection compartment of the collection cart, is technically simpler and lighter, and lower in cost to produce. Moreover, a movable collection cart is to be provided for use in the device.

The solution of the first part of this object, relating to the device, is achieved according to the present invention by a device of the type named above that is characterized in that
in or on the collection cart, there is situated a web-shaped, flexible, or articulated carrier element having a floor portion and having at least two wall portions situated opposite one another, each having at least one upper, free edge,

the carrier element, in an initial position, lies on the floor of the collection cart with a U-shape, running parallel or approximately parallel to at least two oppositely situated side walls and to the floor of the collection cart, or forms at least two oppositely situated side walls and the floor of the collection cart, and

when the collection cart is docked to the compaction material feed device, the carrier element can be shortened or lifted from the free edge of at least one of its wall portions, for the purpose of lifting the compaction material that is situated in the collection cart and is to be compacted.

With the present invention, the device is, advantageously, significantly simplified technically, which makes it less costly to produce. Here, the carrier element is at the same time also used as a conveying element for lifting the compaction material in the collection compartment of the collection cart, for the purpose of transferring the compaction material to the compaction material feed device. Moreover, in this way it is possible not only to realize the collection cart, as part of the device, in a technically simpler manner, but also to realize it with a lower inherent weight, which makes handling it easier and safer for operating personnel. The latter advantage is particularly effective when the device has a plurality of collection carts, as is standard in practical use.

A first development of the device provides that on the free edge of one of the wall portions of the carrier element there is situated a winding shaft that, when the collection cart is docked to the compaction material feed device, can be set into a rotational movement that winds up the carrier element. Through the rotation of the winding shaft, the web-shaped carrier element is wound up and thus shortened, which brings about the desired lifting of the compaction material in the collection compartment of the collection cart. After the collection compartment has been emptied in this way, by rotating the winding shaft in the opposite direction the carrier element is returned to its initial position, in which the collection cart is again ready to receive compaction material to be compacted.

An alternative development of the device provides that a winding shaft is situated on the free edge of each of two oppositely situated wall portions of the web-shaped carrier element, which shafts, when the collection cart is docked to the compaction material feed device, can be set into a synchronous, or approximately synchronous, rotation that winds up the carrier element. In this embodiment, through the rotation of the two winding shafts the web-shaped carrier element is wound up and thus shortened, which also brings about the desired lifting of the compaction material in the collection compartment of the collection cart. Due to the two winding shafts, this embodiment is somewhat more complicated, but has the advantage that practically no relative movements which could be disturbing or could cause wear can occur between the carrier element and the compaction material in the collection compartment of the collection cart. After an emptying of the collection compartment, by winding the shafts in the opposite direction the carrier element is brought back to its initial position, in which the collection cart is again ready to accept compaction material to be compacted.

The present invention further provides that one or more drive elements that can be driven rotationally, e.g., pressure rollers, are situated on the compaction material feed device, which elements, when the collection cart is docked to the compaction material feed device, stand in or can be brought into rotational driving engagement with the winding shaft or shafts of the collection cart, for example with a lever mechanism that lifts the winding shaft or shafts and presses it/them against the drive elements. Here, the collection cart advantageously remains free of complicated and weighty drive elements, because these are situated on the stationary compaction material feed device.

A further alternative embodiment of the device is characterized in that a fixed upper edge of the collection cart is designed as a diverting element via which the one wall portion of the carrier element is diverted by 180° outward and downward, such that when the collection cart is docked to the compaction material feed device, the free edge of the diverted wall portion of the carrier element can be displaced from its initial position into a downward movement. In this embodiment of the device, the winding up of the carrier element is replaced by pulling the carrier element over a diverting element. In this embodiment of the device as well, the desired lifting of the compaction material in the collection compartment of the collection cart is brought about in a technically advantageous simple manner. After emptying of the collection compartment, through oppositely directed displacement over the diverting element the carrier element is brought back into its initial position, in which the collection cart is again ready to receive compaction material to be compacted. The drawing and displacement of the carrier element over the diverting element is usefully done using a suitable power drive, as is further explained below.

An alternative to the last-described embodiment of the device proposes that two fixed upper edges, situated opposite one another, of the collection cart are each formed as a diverting element, via which two oppositely situated wall portions of the carrier element are each diverted by 180° outward and downward, such that, when the collection cart is docked to the compaction material feed device, the free edges of the diverted wall portions of the carrier element can each be displaced downward, from their initial position, in a synchronous or approximately synchronous movement. In this embodiment, through the diversion and movement of two wall portions the web-shaped carrier element is shortened inside the collection compartment, which also brings about the desired lifting of the compaction material in the collection compartment of the collection cart. This embodiment is somewhat more complicated due to the two diversions and movements of wall portions, but it has the advantage that in practice no relative movements that could be disturbing or could cause wear can occur between the carrier element and the compaction material in the collection compartment of the collection cart.

A further alternative to the two above-described embodiments of the device provides that the carrier element has, next to its floor portion, four wall portions that are connected to the floor portion or are one-piece wall portions not immediately connected to one another, each having a free edge, and that four fixed upper edges of the collection cart are each fashioned as a diverting element via which the wall portions of the carrier element are each diverted by 180° outward and downward, such that, when the collection cart is docked to the compaction material feed device, the free edges of the diverted wall portions of the carrier element can be displaced from their initial position downward, in a synchronous or nearly synchronous movement. This embodiment can be advantageous, in particular, for cases of application of the present invention in which relatively heavy compaction material has to be collected, transported, and lifted, because here the load of the compaction material when lifted for the purpose of emptying the collection cart is distributed to all four wall portions of the carrier element.

In the three embodiments of the device described above, in order to bring about the lifting of the compaction material in the collection compartment of the collection cart in a technically simple mariner, according to the present invention it is provided that a vertically displaceable lifting arm system is situated on the compaction material feed device, such that when the collection cart is docked to the compaction material feed device, the lifting arm system stands in, or can be brought into, engagement with the free edge of the diverted wall portion or with the free edges of the diverted wall portions. Here, the collection cart advantageously remains free of complicated and weighty drive elements, because these are situated on the stationary compaction material feed device.

A further alternative to the embodiments named above of the device is characterized in that at the free edge of a first wall portion the carrier element is pivotably connected to an upper edge of the collection cart, and that, going out from the free edge of this first wall portion, a wall portion segment whose surface corresponds essentially or approximately to the cross-sectional surface of the collection compartment of the collection chart is fashioned as a rigid surface, and that the carrier element is capable of being shortened or lifted from the free edge of a second wall portion situated opposite the first wall portion. In this embodiment, the carrier element has a rigid wall portion segment that is pivotable about the associated upper edge of the collection cart, e.g., by hinges, and in the initial state of the collection cart, with lowered carrier element, this wall portion segment forms a substantially vertically running upper part of the first wall portion. When the carrier element is shortened or lifted at its second wall portion for the purpose of lifting the compaction material to be compacted, this gradually leads to an increasing pivoting of the rigid wall portion segment from the vertical orientation into a horizontal or approximately horizontal orientation. In this way, inter alia, it is ensured that the compaction material feed device can remove the compaction material previously collected in the collection cart reliably and completely, without leaving behind undesirable residual compaction material.

For reasons of low weight, the rigid wall portion segment is preferably made of plastic. Wood or light metal are also suitable materials for the rigid wall portion segment.

In a further embodiment of the device, it is provided that the free edge of the second wall portion of the carrier element is connected detachably to the associated upper edge of the collection cart, and that a tensile device or a winding device is situated on the compaction material feed device, which tensile or winding device can, when the collection cart is docked to the compaction material feed device, be brought into engagement with the free edge of the second wall portion of the carrier element and by which the carrier element can be pulled or wound upward, or downward with diversion over the upper edge of the carrier cart. Here, no tensile device or winding device has to be provided on the collection cart itself, thus keeping the collection cart technically simple and therefore low in cost and low in weight, which facilitates the movement of the collection cart, which is usually done manually.

An alternative embodiment of the device is also possible in which a tensile or winding device is situated on the collection cart, in which the free edge of the second wall portion of the carrier element engages with the associated tensile or winding device, and in which the carrier element can be pulled or wound upward, or downward with diversion over the upper edge of the carrier cart, using the tensile or winding device.

In order to enable the necessary tensile length of the tensile device in a space-saving fashion, it is proposed that the tensile device be fashioned in the manner of a pulley having a horizontal, vertically displaceable diverting roller over which the carrier element is guided, and having holding means for the detachable fixing of the free edge of the second wall portion of the carrier element.

In addition, the present invention proposes that, in a raised end position of the carrier element, its rigid wall portion segment coincides substantially or approximately with the cross-section of the collection compartment of the collection cart, and assumes a horizontal position, or a position inclined upward or downward in the direction toward the compaction material feed device. In each case, in the final raised position of the carrier element its rigid wall portion segment should lie as close as possible to the conveying elements, such as teeth of one or more toothed rollers or the like, of the compaction material feed device, but should not come into damaging contact with these conveying elements.

The carrier element in the collection cart can advantageously be realized so as to be low in weight. In order nonetheless to ensure a safe and reliable guiding back of the carrier element in the discharged state, the present invention proposes that on the collection cart there is situated a reset device that preloads the carrier element with a force acting in the direction towards its initial position.

According to a first further development in this regard, it is provided that ballast weights are incorporated or attached as a reset device in or on the portions of the carrier element that lie closest to the lower corners of the collection cart in the initial position of the carrier element, the weights bringing about or supporting a guiding back of the carrier element to its initial position when the carrier element is lowered from a raised position. The ballast weights can, for example, be formed in a technically advantageously simple manner by metallic, rail-shaped, horizontally running profiles that do not hinder the movements of the carrier element, but that guide it back when empty to its desired U-shaped initial position. Advantageously, here the ballast weights are incorporated or fastened in the flexible part of the carrier element, and its position is preferably selected such that the ballast weights are situated at the point where the carrier element, in its initial position, meets the floor of the collection cart or forms this floor. Due to the ballast weights, the vertical parts of the carrier element, i.e., its wall portions, are pulled taut, and the floor portion of the carrier element, which extends between the vertically suspended wall portions, is also pulled smooth, provided that it is not longer than the cross-section of the collection cart.

According to an alternative development in this regard, the reset device can have a tension spring system that produces the preloading force, and that engages, immediately or via flexible tensile means, at two or more points in the transition regions between the wall portions and the floor portion of the carrier element. In this way, after unloading of the collection cart the carrier element can be returned in a technically simple and reliable manner to its initial shape, and thus to a maximum volume of the collection cart, so that an unhindered new collection of compaction material in the collection compartment is then possible.

In a further embodiment of the device according to the present invention, it is provided that the carrier element is loosely suspended on the rest of the collection cart at least at the free edge of one of its wall portions, and that the compaction material feed device has a lifting arm system with which, when the collection cart is docked to the compaction material feed device, the carrier element can be grasped at its loosely suspended free edge remote from the compaction material feed device and lifted upward by pivoting the lifting arm system until it forms a shape inclined downward towards the compaction material feed device, forming a sliding surface for compaction material. In this embodiment of the device as well, the emptying of the collection compartment is brought about by the carrier element and its movement.

In the above-described embodiment of the device, in order to limit the required pivot path of the lifting arm system, it is further provided that the compaction material feed device has a rod-shaped positioning element that, when the collection cart is docked to the compaction material feed device, runs above the upper side of the cart, and on which the carrier element can be positioned, with a bend, when it is pulled up. Thus, when it is pulled up, the carrier element is angled or bent by the stationary positioning element. This, in particular, reduces the height required to raise the lifting arm system upward, so that the device can be used in locations having limited ceiling height. The positioning element usefully runs horizontally over the docked collection cart and parallel to the surface of the carrier element, in order to ensure a uniform, linear positioning of the carrier element on the positioning element without the risk of damaging the carrier element.

So that the compaction material collected in the collection compartment of the collection cart, when raised for the purpose of unloading the collection cart, does not become snagged or caught on the walls of the collection cart covered by a wall portion of the carrier element, in the collection cart at least its side walls to which no wall portion of the carrier element is assigned, are usefully made smooth on the inside, in particular made of plastic or metal plate, or are provided with a smooth-surface inner cladding, in particular, plastic or metal plate. The rest of the collection cart can then have known, mesh-type side walls, or may even have only frame-type side walls, contributing to a simple design and low weight of the collection cart.

It is also possible, with a low outlay of material and time, to retrofit or refit already-existing conventional collection carts, such as those standardly used in individual businesses, in order to then use them as part of the device according to the present invention.

Also in order to achieve the lowest possible weight of the collection cart, the carrier element is preferably formed by a cloth or a fabric or a tarp or a foil or a fine-mesh net, in particular when the compaction material to be collected is light, or by a configuration of profile segments connected to one another in articulated fashion in the manner of roller shutters, in particular when the compaction material to be collected is heavy.

For the distribution of the mechanical loads acting on the carrier element, it is provided that the free edge of a wall portion, or of a plurality of wall portions, or of all the wall portions of the carrier element is formed or reinforced by a respective bar-shaped or tubular profile segment connected to the carrier element.

Alternatively, instead of having a mobile collection cart, the device for collecting compaction material and for conveying the collected compaction material to a press that compacts the compaction material can also be realized with a stationary collection container that has a collection compartment for compaction material to be compacted, and with a compaction material feed device on which the collection container is attached in stationary fashion, the collection container having a floor as well as at least two side walls situated opposite one another, and the compaction material to be compacted being removable, by being lifted upward, from the collection container by the compaction material feed device and being capable of being supplied to a compaction compartment or compaction material supply reservoir of the press, and a web-shaped, flexible, or articulated carrier element, having a floor portion and having at least two oppositely situated wall portions, each having an upper, free edge, being situated on or in the collection container, such that the carrier element, in an initial position, lies on the floor of the collection container running in a U-shape parallel or approximately parallel to at least two side walls situated opposite one another and to the floor of the collection container, or forms at least two oppositely situated side walls and the floor of the collection container, and such that for the purpose of lifting the compaction material that is situated in the collection container and is to be compacted the carrier element is capable of being shortened or lifted from the free edge of at least one of its wall portions.

In a further embodiment of this alternative device, it is provided that the movable collection cart capable of being docked to the compaction material feed device is replaced by the collection container installed in stationary fashion on the compaction material feed device.

All advantages described above and associated with the movable carrier element are thus also achieved in the device equipped with the collection container installed in stationary fashion.

For the solution of the second part of the object, relating to the collection cart for use in the device described above, a collection cart is proposed that has a collection compartment for compaction material to be compacted, and that can be docked to a compaction material feed device of a press, the collection cart having a floor and a system of wheels on its underside, as well as at least two side walls situated opposite one another, and, by being lifted upward, the compaction material to be compacted being removable from the collection cart by means of the compaction material feed device and being capable of being fed to a compaction compartment or compaction material reservoir of the press.

The collection cart according to the present invention is characterized in that

a web-shaped, flexible, or articulated carrier element having a floor portion and having at least two wall portions situated opposite one another, each having an upper free edge, is situated on or in the collection cart,

in an initial position, the carrier element lies on the floor of the collection cart with a U-shape, parallel or approximately parallel to at least two side walls situated opposite one another and to the floor of the collection cart, or forms at least two oppositely situated side walls and the floor of the collection cart, and

for the purpose of lifting the compaction material situated in the collection cart and to be compacted, the carrier element can be shortened or lifted from the free edge of at least one of its wall portions.

The collection cart according to the present invention achieves the advantages explained above in connection with the overall device, and for this reason reference is made to the above description in this regard.

Preferably, a winding shaft is situated on the free edge of one of the wall portions of the carrier element, which shaft can be set into a rotation that winds up the carrier element.

Alternatively, a respective winding shaft can be situated on the free edge of each of two oppositely situated wall portions of the web-shaped carrier element, which shafts can be set into a synchronous or approximately synchronous rotation that winds up the carrier element.

In another embodiment of the collection cart, a fixed upper edge of the collection cart is fashioned as a diverting element via which the one wall portion of the carrier element is diverted by 180°, the free edge of the diverted wall portion of the carrier element being capable of being displaced from its initial position into a downward movement.

Alternatively, two fixed upper edges, situated opposite one another, of the collection cart can each be fashioned as a diverting element, via which two oppositely situated wall portions of the carrier element can each be diverted by 180°, the free edges of the diverted wall portions of the carrier element each being capable of being displaced from their initial position into a synchronous or approximately synchronous downward movement.

According to a further alternative, it is provided that the carrier element has, alongside its floor portion, four wall portions that are connected to the floor portion or are made in one piece and not immediately connected to one another, each having an upper free edge, and that four fixed upper edges of the collection cart are each formed as a diverting element via which the wall portions of the carrier element are each diverted by 180°, the free edges of the diverted wall portions of the carrier element each being displaceable from their initial position in a synchronous or approximately synchronous downward movement.

Yet another alternative embodiment of the collection cart is characterized in that the carrier element at the free edge of a first wall portion is pivotably mounted on an upper edge of the collection cart, and that, going out from the free edge of this first wall portion, a wall portion segment whose surface corresponds substantially or approximately to the cross-sectional surface of the collection compartment of the collection cart is fashioned as a rigid surface, and that the carrier element can be shortened or lifted from the free edge of a second wall portion situated opposite the first wall portion. In this collection cart as well, the compaction material collected therein that is to be compacted is reliably lifted gradually, and in this way is brought into engagement with the compaction material feed device.

For this purpose, in a development it is provided that the free edge of the second wall portion of the carrier element is connected detachably to the associated upper edge of the collection cart, and that, using a tensile device or a winding device with which the free edge of the second wall portion of the carrier element can be brought into engagement, the carrier element can be pulled or wound upward, or downward while being diverted via the upper edge of the carrier cart.

In addition, it is preferably provided that, in a raised end position of the carrier element, its rigid wall portion segment substantially or approximately coincides with the cross-section of the collection compartment of the collection cart, and assumes a horizontal position, or a position inclined upward or downward in the direction of removal of the compaction material to be compacted.

The diverting elements can be, for example, smooth-surfaced struts or profiles over which the wall portions of the carrier element glide with low friction during movement of the carrier element, or they can be one-part or multipart rotatably mounted rollers that rotate below the wall portions of the carrier element when these portions move.

Preferably, in addition, a reset device that preloads the carrier element with a force acting in the direction towards its initial position is situated on the collection cart.

For this purpose, ballast weights that bring about or support a guiding back of the carrier element to its initial position when the carrier element is lowered from a raised position can be incorporated or attached in or on the portions of the carrier element that are situated closest to lower corners of the collection compartment in the initial position of the carrier element.

Alternatively, the reset device has a tension spring system that produces the preloading force, and that engages immediately or via flexible tensile means at two or more points in transition regions between the wall portions and the floor portion of the carrier element.

The present invention further provides that in the collection cart, at least its side walls to which no wall portion of the carrier element is allocated are formed with a smooth surface on the inside, in particular a surface of plastic plate or metal plate, or are provided with a smooth-surfaced inner cladding, in particular plastic plate or metal plate.

Preferably, the carrier element is formed by a cloth or a fabric or a tarp or a foil or a fine-mesh net, or by a system of profile segments connected to one another in articulated fashion in the manner of roller shutters.

Finally, according to the present invention, for the collection cart it is provided that the free edge of a wall portion or of a plurality of wall portions or of all wall portions of the carrier element is formed or reinforced by a respective bar-shaped or tubular profile segment connected to the carrier element.

### BRIEF DESCRIPTION OF THE DRAWINGS

In the following, exemplary embodiments of the present invention are explained on the basis of a drawing.

FIG. 1 shows a collection cart having a carrier element in an exploded view, seen obliquely from above, together with an enlarged detail, as part of the device, in a first embodiment;

FIG. 2 shows the device in a partial side view, having a collection cart according to FIG. 1 docked to a compaction material feed device, of which cart only an upper part is shown here, in a first operating state;

FIG. 3 shows the device of FIG. 2 in the same representation, in a second operating state;

FIG. 4 shows the collection cart in a second embodiment, docked to the compaction material feed device, together with two enlarged details, in an oblique view from above;

FIG. 5 shows the device as a whole, installed on a press, with the collection cart not yet docked to the compaction material feed device, in a further embodiment, in an oblique view from above;

FIG. 6 shows the device of FIG. 5 with the collection cart coupled to the compaction material feed device, here in a partial view, in a first operating state, in an oblique view from above;

FIG. 7 shows the device of FIG. 6 in the same representation, in a second operating state;

FIG. 8 shows the device of FIGS. 6 and 7 in the same view, in a third operating state;

FIG. 9 shows the device as a whole installed on a press, with the collection cart not yet docked to the compaction material feed device, in a further embodiment, in a schematic longitudinal section;

FIG. 10 shows the device of FIG. 9 in a longitudinally sectioned schematic view, seen obliquely from above;

FIG. 11 shows the device of FIGS. 9 and 10 with the collection cart docked to the compaction material feed device, in a first operating state, in a schematic longitudinal section;

FIG. 12 shows the device of FIG. 11 in a longitudinally sectioned schematic view, seen obliquely from above;

FIG. 13 shows the device of FIGS. 9 and 10 with the collection cart docked to the compaction material feed device, in a second operating state, in a schematic longitudinal section;

FIG. 14 shows the device in a further embodiment, installed on a press and with the collection cart not yet docked, in a side view, obliquely from the front;

FIG. 15 shows the device of FIG. 14 with the collection cart now docked, and already partly emptied of the compaction material to be compacted, in a side view;

FIG. 16 shows the device of FIGS. 14 and 15, now with the collection cart almost completely emptied, in a side view;

FIG. 17 shows a detail from FIG. 15, in an enlarged representation;

FIG. 18 shows the device in a further embodiment, installed on a press, and with the collection cart docked and emptied down to a small portion of compaction material to be compacted, in a side view;

FIG. 19 shows the collection cart of the device of FIG. 18 as an individual part, in a front view;

FIG. 20 shows a detail from FIG. 18, in an enlarged representation; and

FIG. 21 shows the device in a further embodiment, installed on a press, and with a collection cart installed in stationary fashion and emptied down to a small portion of compaction material to be compacted, in a side view.

In the following description of the Figures, identical parts in the various Figures are always provided with the same reference characters, so that all reference characters do not have to be explained again for each Figure.

### DETAILED DESCRIPTION OF THE PREFERRED EMBODIMENTS

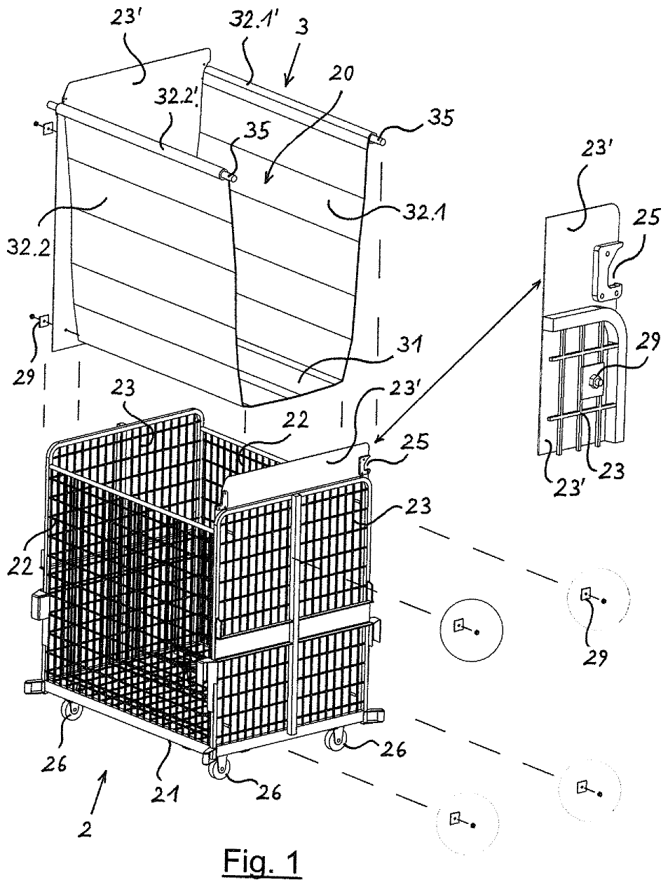

FIG. 1 shows a collection cart 2 having a carrier element 3 in an exploded view, obliquely from above, together with an enlarged detail, as a part of a device for collecting compaction material and for feeding the collected compaction material to a press that presses the compaction material, in a first embodiment.

Here, collection cart 2 is made up of a mesh-type floor 21, two first side walls 22 situated opposite one another, and two second side walls 23 situated opposite one another, the side walls 22, 23 also being meshes. On its underside, collection cart 2 has a system of wheels 26, made up of a total of four wheels or rollers, of which preferably two are steerable. Collection cart 2 can be piloted by an operating person, for example in a supermarket, in order to collect empty packaging or other discarded material and then to supply it to a press in order to produce pressed bales.

Differing from conventional collection carts 2 of this type, in the depicted collection cart 2 an additional carrier element 3 is provided that is installed in collection cart 2. Carrier element 3 is made up of a web-shaped flexible material, such as a fabric, foil, or tarp, and has a floor portion 31 situated at the bottom, as well as two wall portions 32.1, 32.2 made in one piece with the floor portion. The free edges, here at the top, 32.1′, 32.2′ of wall portions 32.1, 32.2 of carrier element 3 are each attached to a winding shaft 35.

In addition, here it is provided to attach a smooth-surfaced inner cladding 23′, for example a plastic plate or metal plate, on the inside of the two second side walls 23, situated opposite one another, of collection cart 2, for which purpose connecting elements 29 are provided, here in the form of washers and screws with nuts.

A respective shaft receptacle 25 is situated at the two lateral upper end regions of each inner cladding 23′, the receptacles being used in paired fashion each to accommodate and mount one of the two winding shafts 35 of carrier element 3. At the far right in FIG. 1, the right upper end region of side wall 23, facing the observer, of collection cart 2 is shown in an enlarged detail, with the associated inner cladding 23′, one of the shaft receptacles 25, and one of the connecting means 29.

In the assembled state of collection cart 2, floor portion 31 of carrier element 3 runs along the upper side of floor 21 of collection cart 2, and the two wall portions 32.1, 32.2 of carrier element 3 run parallel to the first side walls 22 of collection cart 2. In this state of collection cart 2, compaction material to be compacted, such as paper, cardboard, boxes, and the like, as are found, for example, in a supermarket, can be collected in collection compartment 20 of the cart.

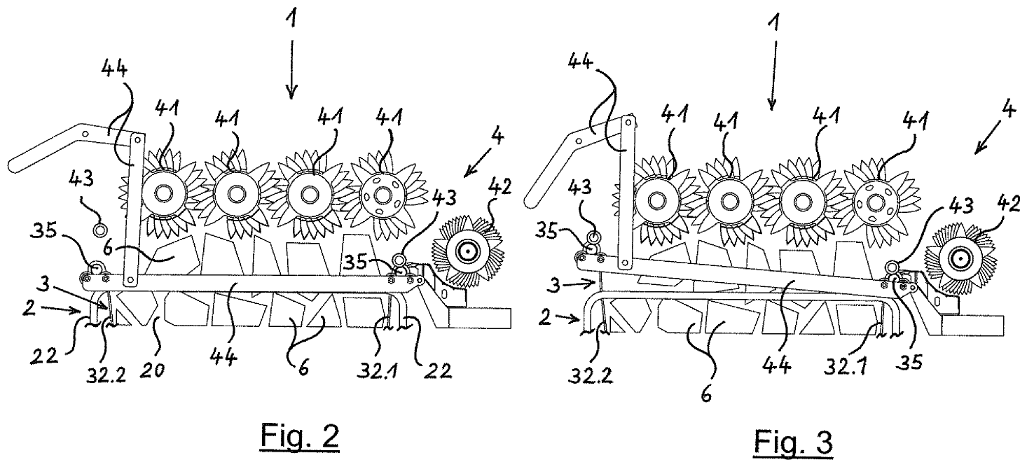

FIGS. 2 and 3 show device 1 in a partial side view, with collection cart 2 docked to a compaction material feed device 4 according to FIG. 1, of which cart only an upper part is shown here, in two different operating states. Compaction material feed device 4 has a lifting arm system 44 that can be pivoted upward and downward by means of a drive (not shown here) at its end at the left in FIGS. 2 and 3.

In addition, compaction material feed device 4 has two drive elements 43 that can be driven rotationally, which, depending on the pivot position of lifting arm system 44, can optionally be out of driving engagement with winding shafts 35, as shown in FIG. 2, or in driving engagement with winding shafts 35, as shown in FIG. 3.

In the exemplary embodiment according to FIGS. 2 and 3, the two winding shafts 35 are set into rotation in opposite directions by drive elements 43 for the purpose of emptying collection cart 2, causing web-shaped carrier element 3, starting from its two free edges 32.1′, 32.2′32, to be gradually wound onto winding shafts 35. This causes compaction material 6 situated in collection compartment 20 of collection cart 2 to be moved upward, so that it can gradually be grasped by a system of a plurality of (here four) supply rollers 41, and transported to the right, in the direction towards a filling rotor 42. Through its rotation, filling rotor 42 conveys, in a known manner, compaction material 6 to be compacted into the compaction compartment of a press (not shown here) connected downstream from device 1.

After a complete emptying of collection cart 2, its carrier element 3 is guided back to its initial position, suitable for new collection of compaction material 6, by unwinding wall portions 32.1, 32.2 from winding shafts 35. After the decoupling of compaction material feed device 4, collection cart 2 can again be moved to positions provided for the collection of compaction material.

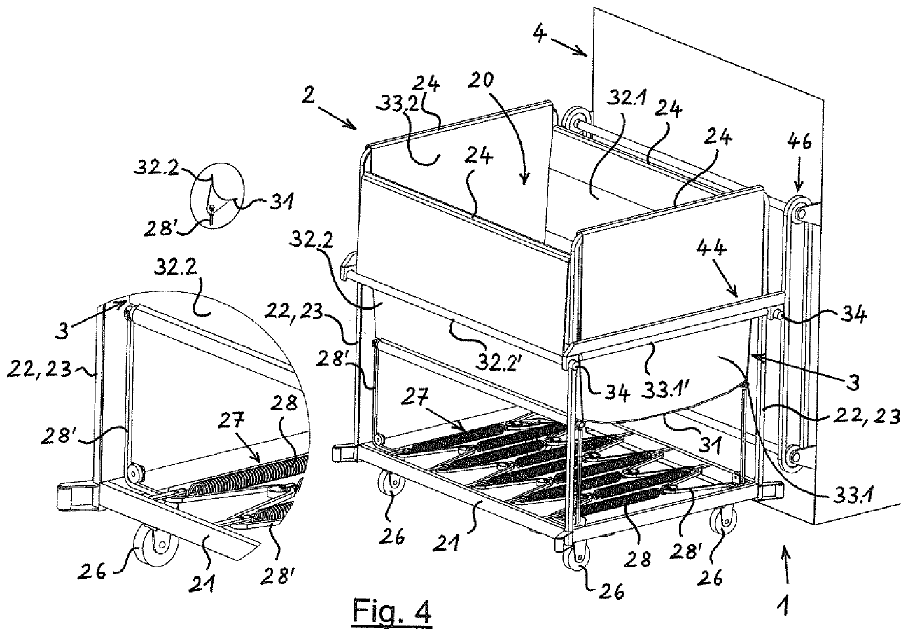

FIG. 4 shows collection cart 2 in a second embodiment, docked to the compaction material feed device 4, together with two enlarged details, in an oblique view from above. This collection cart 2 has two characteristic aspects. On the one hand, collection cart 2 here has a carrier element 3 that has, in addition to its floor portion 31 and its first and second wall portions 32.1, 32.2, two further wall portions 33.1, 33.2, so that collection compartment 20 of collection cart 2 is here completely bounded by carrier element 3. On the other hand, in collection cart 2 a reset device 27 is provided that brings about a reliable guiding of carrier element 3 back to its initial position after an emptying of collection cart 2.

A further characteristic of this embodiment of collection cart 2 is that side walls 22, 23 of collection cart 2 are formed only by some struts, and each have an upper edge 24 via which the first and second wall portions 32.1, 32.2, 33.1, 33.2 of carrier element 3 are each diverted by 180° outward and downward.

Compaction material feed device 4, partly visible at the far right in FIG. 4, here includes a lifting arm system 44 that has two arms that freely protrude approximately horizontally, extending to the left and to the right from collection cart 2, which is docked to compaction material feed device 4. At the front and at the rear, lifting arm system 44 stands in engagement with four profile segments 34, here in the form of rods, that run along the free edges 32.1′, 32.2′, 33.1′, 33.2′ of the four wall portions 32.1, 32.2, 33.1, 33.2. Using a drive 46 to move the arms of lifting arm system 44 downward, the free edges 32.1′, 32.2′, 33.1′, 33.2′ of wall portions 32.1, 32.2, 33.1, 33.2 of carrier element 3 are drawn downward, causing, by means of the diversions of the wall portions 32.1, 32.2, 33.1, 33.2 over the upper edges 24, a lifting of floor portion 31 of carrier element 3. Thus, in this collection cart 2 as well compaction material collected in the cart can be gradually lifted upward and transferred to conveying elements (not shown here) situated above collection cart 2, which is docked to compaction material feed device 4, such as supply rollers 41 according to FIGS. 2 and 3.

The mentioned reset device 27, for guiding carrier element 3 back after an emptying of collection cart 2, is situated at the height of floor 21 of collection cart 2, and is made up of a tension spring system 28 and tensile means 28′. When floor portion 31 of carrier element 3 is raised, tension spring system 28 is tensioned via the tensile means 28′ connected to the edges of the lower side of floor portion 31. The guiding of carrier element 3 back to its initial position then takes place through the force of the tensioned tension spring system 28, and via tensile means 28′, which engage at the lower side at the edges of floor portion 31 of carrier element 3.

Here as well, a wheel system 26 for the manual movement of collection cart 2 is provided on the underside of floor 21 of collection cart 2.

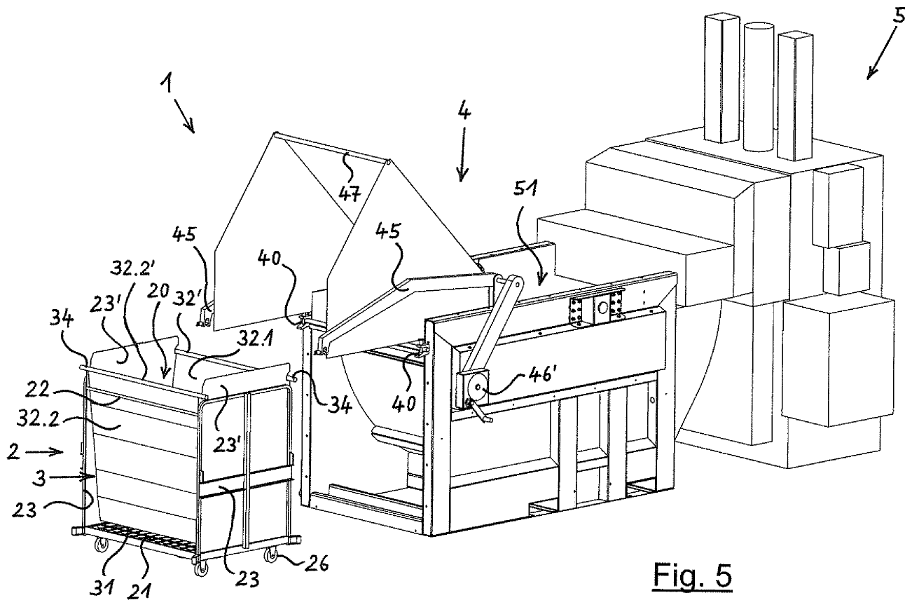

FIG. 5 shows device 1 as a whole, installed on a press 5, with collection cart 2 not yet docked to compaction material feed device 4, in a further embodiment, in an oblique view from above.

Here, collection cart 2 again has a mesh-type floor 21 having a system of wheels 26 on its underside, and first and second side walls 22, 23 formed by only a few struts. Carrier element 3 is placed into collection cart 2, the carrier element here again being web-shaped, having a lower floor portion 31 and being fashioned with two first and second wall portions 32.1, 32.2 that extend upward from the floor portion, and are made in one piece therewith, and which extend along first side walls 22 of collection cart 2. The two second side walls 23 of collection cart 2 are here again covered with smooth-surfaced inner claddings 23′. Together with wall portions 32.1, 32.2 of carrier element 3, this inner cladding 23′ forms collection compartment 20 of collection cart 2, and prevents snagging or sticking of carrier element 3 and of parts of the compaction material when it is raised for the purpose of emptying collection cart 2, which could occur given side walls 23 realized as coarse meshes.

Two rod-shaped or tubular profile segments 34 are attached to free edges 32.1′, 32.2′ of wall portions 32.1, 32.2, whose ends are respectively situated in two receptacles in the upper lateral region of the two inner claddings 23′ on the two second side walls 23 of collection cart 2.

On its end face oriented towards collection cart 2 to be docked, compaction material feed device 4 has two docking elements 40, here fashioned for interaction with the lateral ends of profile segment 34, facing compaction material feed device 4, of collection cart 2.

In addition, compaction material feed device 4 has a two-armed lifting arm system 45 that can be pivoted upward by a drive 46′, from an initial position shown in FIG. 5. Between the arms of lifting arm system 45, a stationary, rod-shaped positioning element 47 is situated, in a raised position and running transverse to the arms.

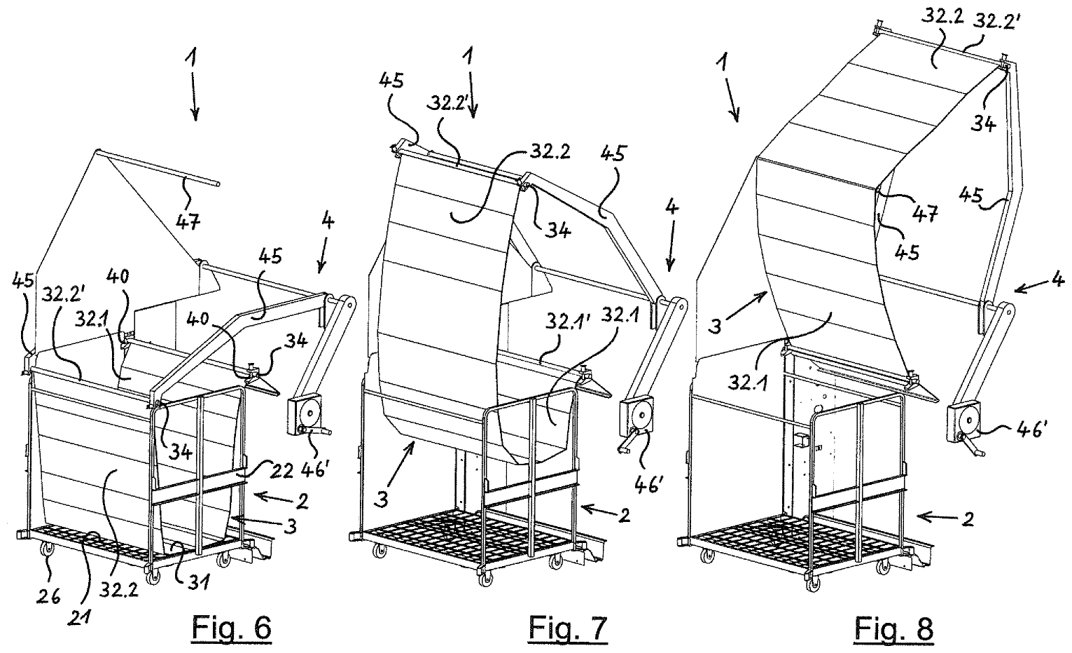

In addition, compaction material feed device 4 here has a compaction material supply reservoir 51 to which the compaction material collected in collection cart 2 can first be transferred, as is explained in more detail on the basis of FIGS. 6 through 8.

When collection cart 2 is docked, lifting arm system 45 can be brought into engagement, with its free ends, with profile segment 34, situated remote from compaction material feed device 4, of carrier element 3, as is shown in FIG. 6, which shows device 1 of FIG. 5 with the collection cart 2 coupled to compaction material feed device 4 (here shown partially), in a first operating state, in an oblique view from above. Collection cart 2 is here docked to compaction material feed device 4 by docking elements 40, and the free ends of lifting arm system 45 stand in engagement with profile segment 34 at the free edge 32.2′, situated remote from compaction material feed device 4, of wall portion 32.2 of carrier element 3.

FIG. 7 shows a device of FIG. 6 in the same representation, in a second operating state, in which lifting arm system 45 is pivoted upward by a certain angle by drive 46′. During this pivot movement of lifting arm system 45, free edge 32.2′, which stands in engagement with the lifting arm system, of carrier element 3 is carried along and moved upward, causing carrier element 3 as a whole to be lifted inside collection cart 2. In this way, compaction material (not shown) situated in collection cart 2 is lifted and, without additional conveying elements, is here transferred into the compaction material supply reservoir 51 (visible in FIG. 5) over the free edge 32.1′, facing compaction material feed device 4, of carrier element 3.

FIG. 8 shows device 1 of FIGS. 6 and 7 in the same representation, in a third operating state in which lifting arm system 44 has reached its upper end position. In this position, carrier element 3 is lifted upward completely out of the rest of collection cart 2, and its approximate center region is positioned, with a bend, on positioning element 47. In this operating state, carrier element 3 forms a sliding surface below positioning element 47, inclined downward towards compaction material feed device 4, over which the compaction material previously collected in collection cart 2 slides downward due to the force of gravity.

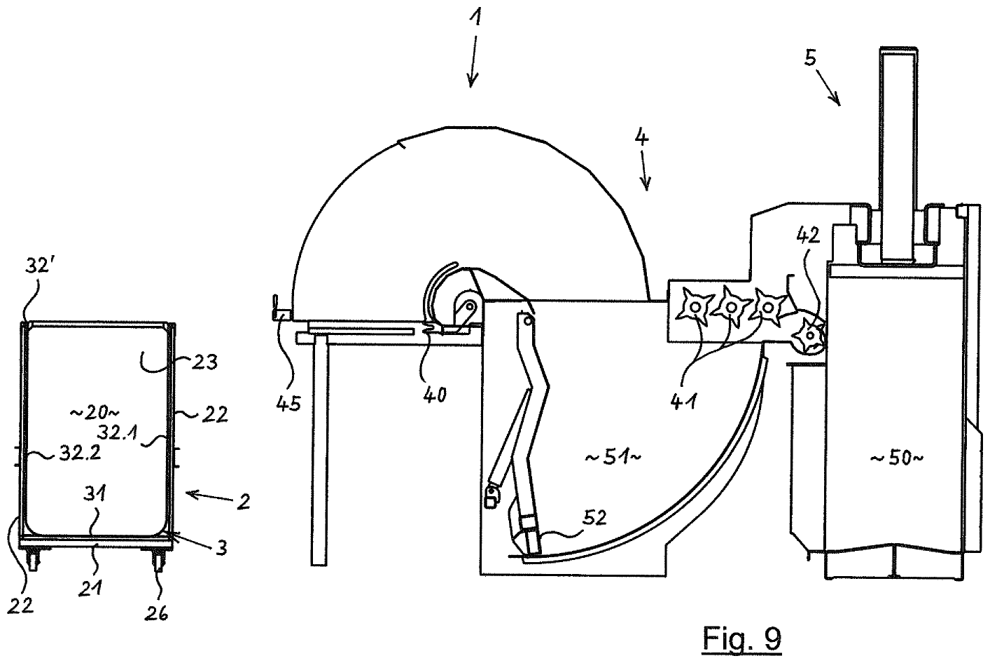

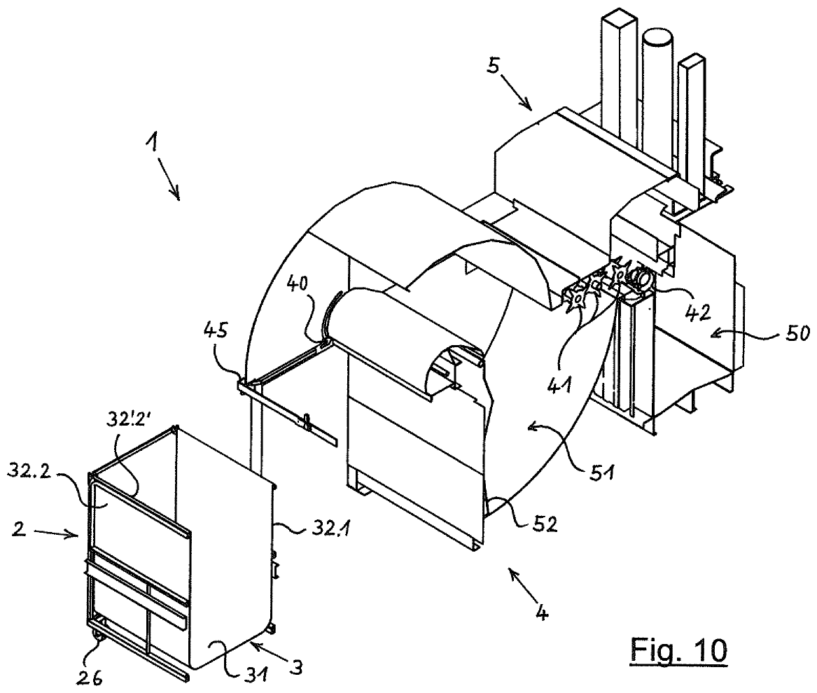

FIGS. 9 and 10 show device 1 as a whole, placed onto a press 5, with collection cart 2 not yet docked to compaction material feed device 4, in a further embodiment, once in a schematic longitudinal section and once in a longitudinally sectioned schematic view seen obliquely from above.

At left in FIG. 9 and FIG. 10, collection cart 2, not yet docked to compaction material feed device 4 and forming a part of device 1, is visible with its individual parts described above. At the right, compaction material feed device 4 is connected to the cart, as a further part of device 1. Compaction material feed device 4 here as well has a lifting arm system 45, which is for the most part hidden. In addition, compaction material feed device 4 here as well has two docking elements 40 for collection cart 2, of which only one is visible.

On the side of compaction material feed device 4 oriented away from collection cart 2, there is situated a compaction material supply reservoir 51 having a curved floor, over which a conveyor pendulum 52 can be pivoted back and forth by a power drive (not shown here). In the upper right end region of compaction material supply reservoir 51, a system of supply rollers 41 that can be rotationally driven is provided, followed by, further to the right, a filling rotor 42, by which compaction material to be compacted can be conveyed into a compaction compartment 50 of press 5, connected downstream.

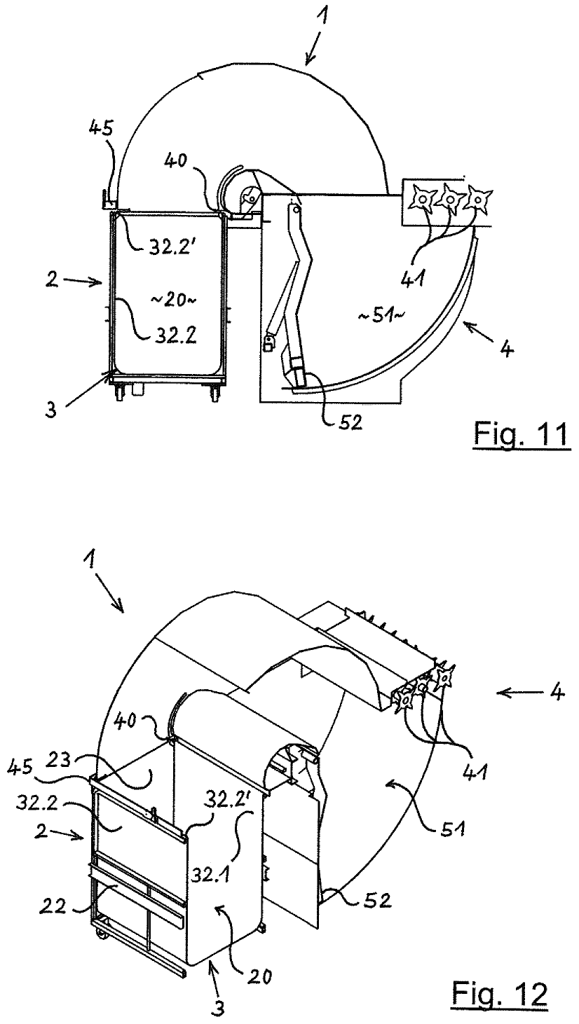

FIGS. 11 and 12 show device 1 of FIGS. 9 and 10 with collection cart 2 docked to compaction material feed device 4, in a first operating state, once in a schematic longitudinal section and once in a longitudinally sectioned schematic view, seen obliquely from above. Collection cart 2 is mechanically connected to compaction material feed device 4 by docking elements, and is fixed in its position. Lifting arm system 45 has entered into engagement with free edge 32.2′ of first wall portion 32.2, remote from compaction material feed device 4, of carrier element 3. Carrier element 3, with the compaction material (not shown here) situated in collection compartment 20, is still completely inside collection cart 2, because here lifting arm system 45 has not yet been pivoted upward.

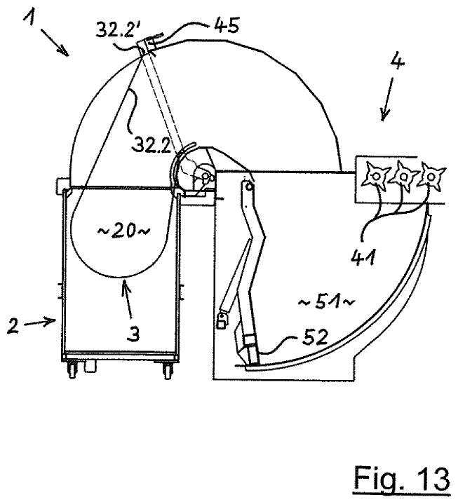

FIG. 13 shows device 1 of FIGS. 9 through 12 with collection cart 2 docked to compaction material feed device 4, in a second operating state, in a schematic longitudinal section. In this operating state, lifting arm system 45 is pivoted upward, carrying free edge 32.2′, with which it is engaged, and thus carrier element 3 upward along with it. FIG. 13 shows an intermediate position of lifting arm system 45 and of carrier element 3.

At the end of the pivot movement of lifting arm system 45, this system points in the direction towards compaction material feed device 4, and to supply rollers 41 situated thereon, carrier element 3 then being completely lifted out of collection cart 2. As a result, the compaction material (not shown here) collected in collection cart 2 is lifted upward out of collection compartment 20 of collection cart 2 and, according to FIG. 13, is conveyed to the right, without additional conveying means, into compaction material supply reservoir 51, into which the compaction material falls due to the force of gravity.

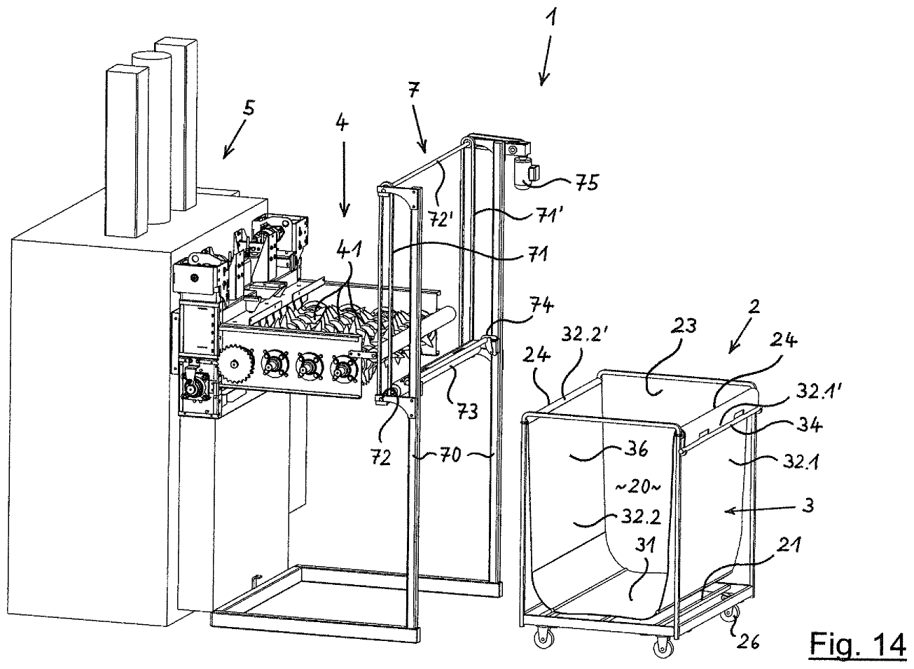

FIG. 14 shows device 1 in another embodiment, docked to a press 5, and with collection cart 2 not yet docked, in a side view seen obliquely from the front. Here as well, collection cart 2 has a collection compartment 20 that is limited at two opposite sides and at the bottom by carrier element 3. At the rear side of collection cart 2 in FIG. 14, there is situated a fixed side wall 23. At the front side of collection cart 2, in practice there is also situated a side wall 23, but here it is omitted so that carrier element 3 will be visible. Carrier element 3 is made up of two first and second wall portions 32.1, 32.2 situated opposite one another, and a floor portion 31.

The upper part of second wall portion 32.2 is formed here by a rigid wall portion segment 36, for example in the form of a light plate made of plastic that is part of carrier element 3 and is connected to the rest of carrier element 3. The parts of carrier element 3 not formed by rigid wall portion segment 36 are made of a flexible material, for example a tarp or a fabric or the like, as described above.

At free edge 32.1′, first wall portion 32.1 of carrier element 3 is diverted by 180° outward and upward over upper edge 24 of collection cart 2, and is fixed in a collecting position of collection cart 2. For reinforcement, free edge 32.1′ is provided with a bar-shaped or tubular profile segment 34.

On the oppositely situated free edge 32.2′ of second wall portion 32.2, formed partly by rigid wall portion segment 36, rigid wall portion segment 36 is connected along its upper edge to collection cart 2, by a pivot axle running parallel to the upper edge 24 of collection cart 2 there, so as to be capable of pivoting motion.

Underneath carrier element 3, collection cart 2 has a floor 21, formed by struts running in parallel and having a system of wheels 26 on its underside, with which collection cart 2 can be pushed by an operator, standardly between a location for collecting compaction material to be compacted and the press for compacting the compaction material to form compacted bales.

At far left in FIG. 14, a belt press 5 of the standard design is shown schematically, and is not further described here. Connected before press 5 is a compaction material feed device 4, with the aid of which compaction material to be compacted can be removed from collection cart 2 and supplied to a compaction chamber inside press 5.

Compaction material feed device 4 has a plurality of supply rollers 41 that run parallel to one another with horizontal axes and can be rotationally driven, which rollers are made with radially protruding teeth and are situated at a height that permits collection cart 2 to be moved under the system of supply rollers 41.

In addition, here compaction material feed device 4 has a tensile device 7 with the aid of which carrier element 3 of collection cart 2, when it is coupled to compaction material feed device 4, can be moved and adjusted in order to lift compaction material collected in collection compartment 20 of collection cart 2. For this purpose, tensile device 7 has a frame 70 made up of vertical and horizontal struts, as well as, laterally, two drive elements 71, 71′ that run parallel to one another in the vertical direction, such as belts or chains guided on two horizontal shafts 72, 72′ that are guided parallel to one another at the top and approximately centrically on frame 70. A diverting roller 73 is connected to drive elements 71, 71′, which diverting roller runs in the horizontal direction parallel to shafts 72, 72′. At the level of lower shaft 72, holding means 74 are situated on frame 70, with which holding means the free edge 32.1′ of first wall portion 32.1 of carrier element 3 can be brought into a detachable holding engagement.

Drive elements 71, 71′ can be set into motion by a motor 75 situated on frame 70. In this way, diverting roller 73 connected thereto can optionally be moved upward and downward.

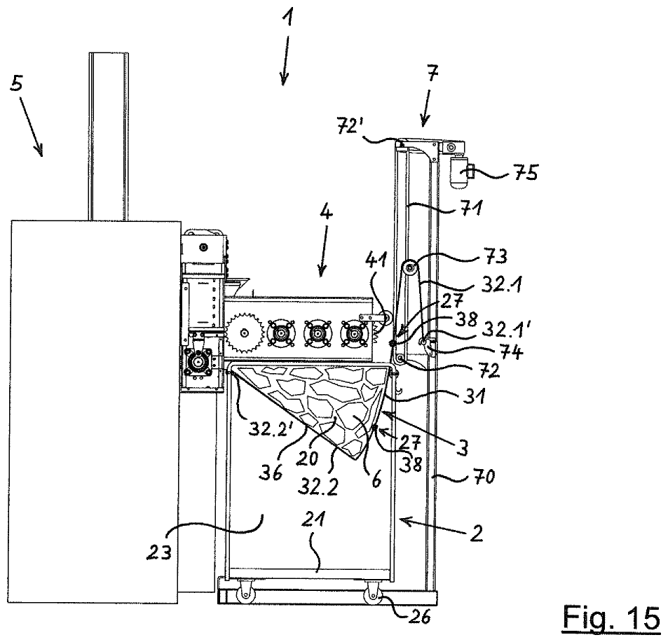

FIG. 15 shows device 1 of FIG. 14, with collection cart 2 now docked and already partly emptied of compaction material 6 to be compacted, in a side view. The docking of collection cart 2 usually takes place in its completely loaded state, in which free edge 32.1′ of first edge region 32.1 assumes the position shown in FIG. 14. After the docking of collection cart 2 to compaction material feed device 4, free edge 32.1′ of first wall portion 32.1 is detached from collection cart 2, is guided over diverting roller 73, which is in its lowest position, and is brought into holding engagement with holding means 74 of tensile device 7. By switching on motor 75, diverting roller 73 is gradually moved upward by drive elements 71, 71′, causing carrier element 3 as a whole, and thus also compaction material 6 to be compacted situated therein, to be gradually raised. At the same time, supply rollers 41 of compaction material feed device 4 are set into rotation, and convey, from above, compaction material 6 out of collection compartment 20 and into the interior of press 5.

During the lifting of first wall portion 32.1 of carrier element 3 by diverting roller 73, rigid wall portion segment 36 of second wall portion 32.2 is pivoted about free edge 32.2′ of second wall portion 32.2. For this purpose, rigid wall portion segment 36 is pivotably mounted at its upper edge, for example by hinges, on the upper edge facing press 5 of collection cart 2.

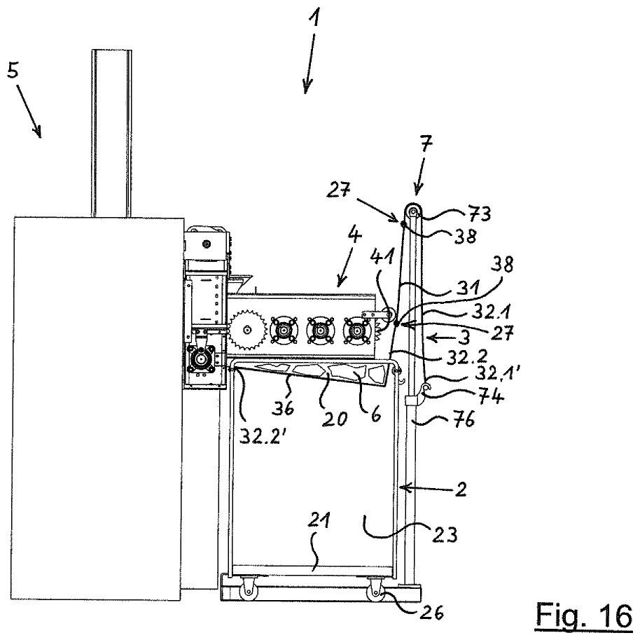

FIG. 16 shows device 1 of FIGS. 14 and 15, now with collection cart 2 almost completely emptied, and with a different embodiment of tensile device 7, in a side view.

In the example of FIG. 16, tensile device 7 is made up of two piston-cylinder units 76 that are situated parallel to one another and that run vertically, and that, seen perpendicular to the plane of the drawing of FIG. 16, have a distance from one another such that collection cart 2 can pass between them. At the upper end of each of the cylinders of the two piston-cylinder units 76, there is attached a respective holding means 74 with which free edge 32.1′ of wall portion 32.1 can be brought into detachable holding engagement.

The piston rods of the cylinders can be pushed outward from the cylinders. At the upper end of the piston rod of the two piston-cylinder units 76, diverting roller 73 is mounted, which in FIG. 16 has reached a position close to its topmost position. In this position of diverting roller 73, with carrier element 3 guided over it, rigid wall portion segment 36 has achieved an approximately horizontal position that substantially coincides with the cross-section of collection compartment 20 of collection cart 2. Through further lifting of carrier element 3, until a horizontal position of rigid wall portion segment 36 is reached, supply rollers 41 can completely remove compaction material 6 from collection compartment 20 and supply it to press 5, without compaction material 6 remaining in collection cart 2 in an undesired manner

Both in FIG. 15 and in FIG. 16, a reset device 27 is shown that is modified compared to reset device 27 described above on the basis of FIG. 4. In reset device 27 according to FIGS. 15 and 16, it is provided that in or on the regions of carrier element 3 that, in its initial position, are situated closest to lower corners of collection compartment 20, a ballast weight 38 is incorporated or attached as reset device 27, which brings about or supports a guiding of carrier element 3 back into its initial position when carrier element 3 is lowered from a raised position.

Here, ballast weights 38 are metallic, bar-shaped profiles that run horizontally and that do not hinder the movements of carrier element 3, but bring about its guiding back, when empty, to its desired U-shaped initial position. Usefully, here ballast weights 38 are enclosed or fastened in the flexible part of carrier element 3, ballast weights 38 being situated at the position where carrier element 3, in its initial position, has a transition from floor portion 31 to each of wall portions 32.1, 32.2. Through the action of ballast weights 38, the vertical parts of carrier element 3, i.e. its wall portions 32.1, 32.2, are pulled taut, and floor portion 31 of carrier element 3, which extends between the vertically suspended wall portions 32.1, 32.2, is also pulled smooth, provided that it is not longer than the cross-section of collection compartment 20.

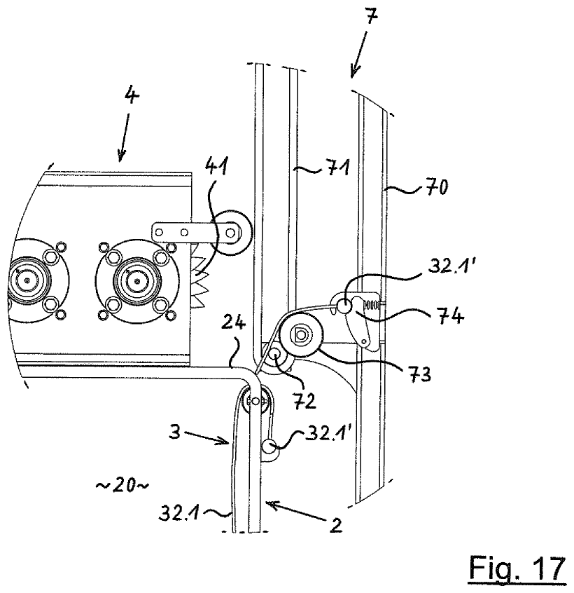

FIG. 17 shows a detail from FIG. 15 in an enlarged representation, illustrating the connection of free edge 32′ of first wall portion 32.1 of carrier element 3

holding means 74 of tensile device 7. During the docking of collection cart 2 to compaction material feed device 4, free edge 32.1′ is still fastened to collection cart 2. After the docking, an operator detaches free edge 32.1′ of first wall portion 32.1 of carrier element 3 from collection cart 2, guides it over diverting roller 73, which is in its lowest position, and then brings it into detachable holding engagement with stationary holding means 74 of tensile device 7. Subsequently, by moving diverting roller 73 upward, carrier element 3 can be gradually lifted in order to supply compaction material collected in collection compartment 20 of collection cart 2 to supply rollers 41 of compaction material feed device 4.

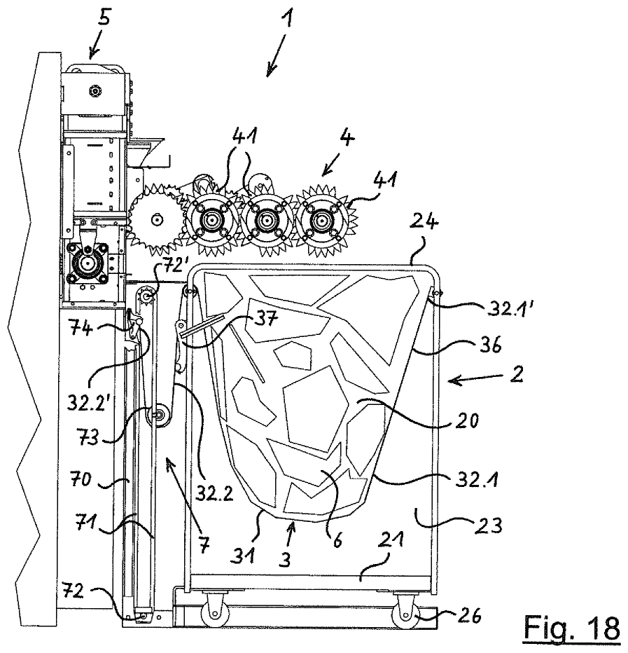

FIG. 18 shows device 1 in another embodiment, installed on a press 5, and having collection cart 2 docked and already emptied down to a small portion of compaction material 6 to be compacted, in a side view.

Here as well, collection cart 2 has a floor 21 having a system of wheels 26 on its underside so that it can be moved by an operator. In addition, here as well a carrier element 3 is situated in collection cart 2, which element has a first wall portion 32.1, a floor portion 31, and a second wall portion 32.2. In the background, fixed side wall 23 of collection cart 2 is situated on the cart. A front, fixed side wall, also present in reality, is omitted in FIG. 18 so that carrier element 3 will be visible.

In the example of FIG. 18, an upper part of first wall portion 32.1 of carrier element 3 is fashioned as rigid wall portion segment 36, whose upper edge forms edge 32.1′ of first wall portion 32.1. Along this edge 32.1′, wall portion segment 36 is connected in pivotably articulated fashion to upper edge 24 of collection cart 2. The remaining part of carrier element 3 is made of a flexible material, such as a tarp or a web of fabric, or the like.

In the example of FIG. 18 as well, a tensile device 7 is present, which here is situated between collection cart 2 and the side of press 5 facing the cart. Here as well, tensile device 7 has a vertical frame 70 having two circulating drive elements 71, 71′, such as chains or belts, that are guided over two shafts 72, 72′ running horizontal and parallel to one another and situated at a vertical distance from one another, and that can be driven by these shafts.

Here as well, a horizontally running diverting roller 73 is mounted on drive elements 71, 71′, which roller is movable in the vertical direction by moving drive elements 71, 71′.

In an upper region of frame 70, two holding means 74 are situated in stationary fashion at a horizontal distance from one another, with which holding means free edge 32.2′ of second wall portion 32.2 of carrier element 3 is brought into detachable engagement in FIG. 18. To produce this engagement, a swivel clip 37 is situated on collection cart 2, and an operator can bring free edge 32.2′ of wall portion 32.2 into holding engagement with holding means 74 by manually swiveling this clip.

By moving diverting roller 73 downward, the flexible part of carrier element 3, diverted outwardly and downward over the upper edge 24 of collection cart 2 by 180°, is pulled downward, causing compaction material 6 to be compacted in collection compartment 20 of collection cart 2 to be gradually lifted, and thus supplied to supply rollers 41 of compaction material feed device 4.

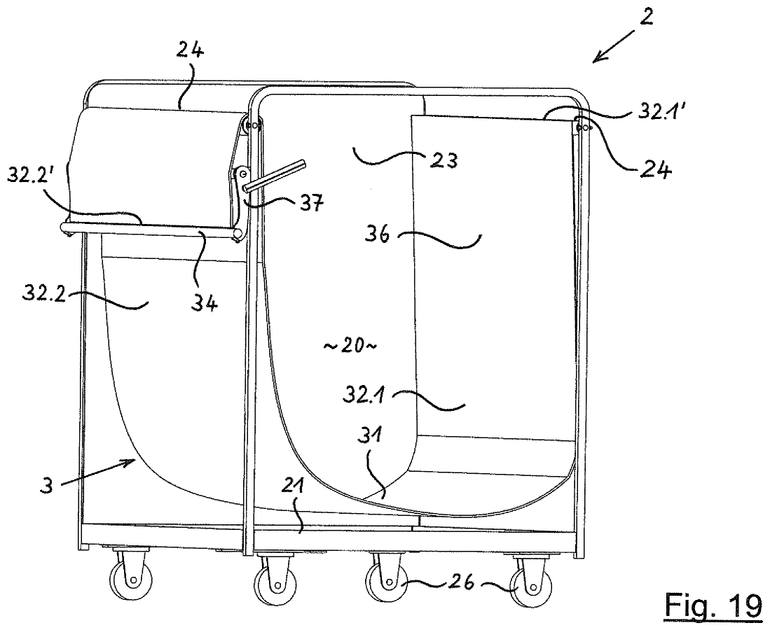

FIG. 19 shows collection cart 2 of FIG. 18 as an individual part in a front view. At bottom in FIG. 19, floor 21 of collection cart 2 is visible, with wheel system 26 on its underside. Struts extend upward from floor 21, forming at the top the upper edge 24 of collection cart 2. In the background is situated the one fixed side wall 23 of collection cart 2. An oppositely situated additional fixed side wall is not shown in FIG. 19 for reasons of visibility.

Carrier element 3 is situated in collection cart 2, with wall portions 32.1, 32.2, and floor portion 31. The predominant part of first wall portion 32.1, at right in FIG. 19, is formed by rigid wall portion segment 36, which is connected, along free upper edge 32.1′, in articulated fashion to upper edge 24 of collection cart 2.

At the opposite side, at left in FIG. 19, of collection cart 2, second wall portion 32.2 is diverted downward by 180° over upper edge 24 of collection cart 2, and at its free edge 32.2′ is brought into detachable holding engagement with swivel clip 37. In this state of collection cart 2, the cart can be filled with compaction material to be compacted that is held in collection compartment 20 of collection cart 2.

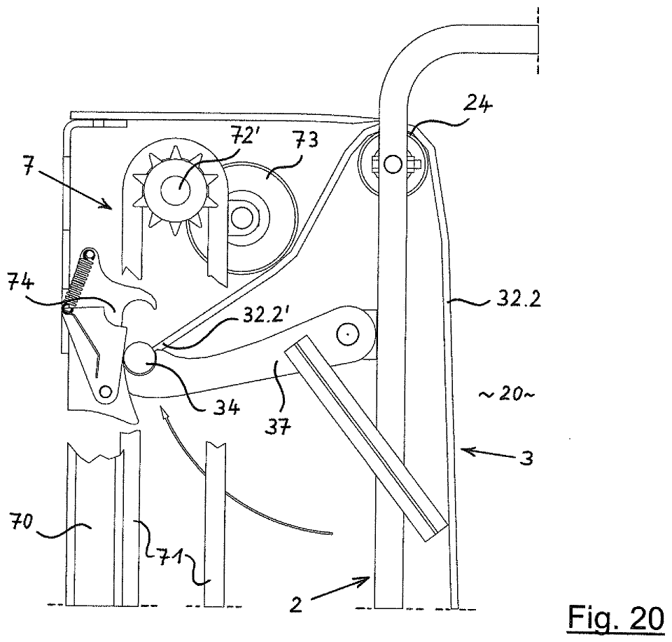

FIG. 20 shows a detail of FIG. 18, in an enlarged representation. At right in FIG. 20, a small part of collection cart 2 can be seen, with a part of second wall portion 32.2 of carrier element 3, which is diverted over upper edge 24 of collection cart 2, here made with a roller in order to reduce friction. Free edge 32.2′ of second wall portion 32.2 is still in engagement with swivel clip 37, which is already swiveled from the initial position shown in FIG. 19 in the direction towards holding means 74 of tensile device 7. At the end of the swivel movement indicated by the arrow in FIG. 19, swivel clip 37 hands over free edge 32.2′, reinforced by a bar-shaped or tubular profile segment 34, of second wall portion 32.2 to holding means 74, which hold profile segment 34 detachably in a holding engagement by means of a spring-loaded locking mechanism.

Above swivel clip 37, diverting roller 73 is visible, here in its uppermost position. Using tensile device 7, diverting roller 73 can subsequently be moved downward, causing the lifting described on the basis of FIG. 18 of carrier element 3, with the compaction material to be compacted situated therein.

For all described embodiments of device 1 for collecting compaction material and for supplying the collected compaction material to a press that compacts the compaction material, it is characteristic that carrier element 3, in addition to its bearing function during the collection of compaction material 6 in collection cart 2, advantageously also takes over the function of a conveying element when it is emptied at compaction material feed device 4.

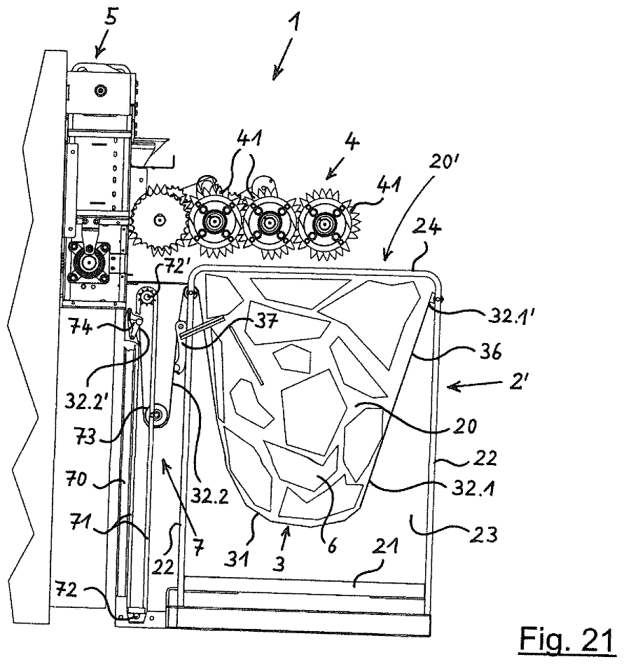

FIG. 21 shows device 1 in a further embodiment, installed on a press 5, and having a collection container 2′ that is installed in stationary fashion and has already been emptied down to a small portion of compaction material 6 to be compacted. It is characteristic for this embodiment of device 1 that it has, instead of the movable collection cart capable of being docked to compaction material feed device 4 and separated therefrom, a collection container 2′ that is installed in stationary fashion. Apart from its mobility, collection container 2′ has all the features of collection cart 2 described above in connection with unit 1 according to the present invention, and in particular has carrier element 3 that can be moved for the purpose of lifting compaction material 6 that is to be compacted and is situated in collection cart 2.

The upwardly open feed-in area 20′ situated on collection container 2′, at top right in FIG. 21, is used for the manual or machine-assisted introduction of compaction material to be compacted into collection compartment 20 of collection container 2′.

For the enlargement as needed of feed-in area 20′, it can additionally be provided that the system of supply rollers 41 can be pivoted upward and to the left.

Carrier element 3 of collection container 2′, and the means for raising and lowering carrier element 3 of collection container 2′, can be realized in a manner corresponding to the various embodiments described above of carrier element 3 of collection cart 2 and the means for raising and lowering carrier element 3 of collection cart 2, so that with regard to the further parts shown in FIG. 21 reference is made to the above description, in particular of FIG. 18.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE CHARACTERS

1 device
2 collection cart
2′ collection container
20 collection compartment
20′ feed-in region
21 floor
22 first side walls
23 second side walls
23′ inner cladding on 23
24 upper edges of 22, 23
25 shaft receptacles for 35
26 system of wheels
27 reset device
28 system of tension springs
28′ tensile means in 28
29 connecting elements for 23′
3 carrier element
31 floor portion
32.1 first wall portion
32.1′ free edge of 32.1
32.2 second wall portion
32.2′ free edge of 32.2
33.1 third wall portion
33.1′ free edge of 33.1
33.2 fourth wall portion
34 profile segments on 32.1′, 32.2′, 33.1′, 33.2′
35 winding shafts
36 rigid wall portion segment
37 swiveling clip
38 ballast weights
4 compaction material feed device
40 docking elements
41 supply rollers
42 filling rotor
43 drive elements for 35
44 lifting arm system
45 lifting arm system
46 drive for 44
46′ drive for 45
47 positioning element
5 press
50 press compartment
51 compaction material supply reservoir
52 conveying pendulum in 51
6 compaction material
7 tensile device
70 frame
71, 71′ drive elements
72, 72′ shafts
73 diverting roller
74 holding means
75 motor
76 piston-cylinder units

1-37. (canceled)

38. A device for collecting compaction material and for supplying the collected compaction material to a press that compacts the compaction material, having at least one movable collection cart that has a collection compartment for compaction material to be compacted, and having a compaction material feed device to which the collection cart is capable of being docked, the collection cart having a floor and a system of wheels on its underside, as well as at least two side walls situated opposite one another, and the compaction material to be compacted being removable, by being lifted upward, from the collection cart by the compaction material feed device and being capable of being supplied to a compaction compartment or compaction material supply reservoir of the press, wherein
on or in the collection cart there is situated a web-shaped, flexible, or articulated carrier element having a floor portion and having at least two wall portions situated opposite one another, each having at least one upper, free edge,
the carrier element, in an initial position, lies on the floor of the collection cart, running parallel or approximately parallel to at least two side walls situated opposite one another and to the floor of the collection cart, or forms at least two oppositely situated side walls and the floor of the collection cart, and
when the collection cart is docked to the compaction material feed device, for lifting the compaction material that is to be compacted and is situated in the collection cart, the carrier element can be shortened or can be lifted from the free edge of at least one of its wall portions.

39. The device as recited in claim 38, wherein a winding shaft is situated on the free edge of one of the wall portions of the carrier element, which shaft, when the collection cart is docked to the compaction material feed device, is configured to be set into a rotation that winds up the carrier element.

40. The device as recited in claim 38, wherein a respective winding shaft is situated on the free edge of each of two oppositely situated wall portions of the web-shaped carrier element, which shafts, when the collection cart is docked to the compaction material feed device, are configured to be set into a synchronous or approximately synchronous rotation that winds up the carrier element.

41. The device as recited in claim 39, wherein one or more drive elements configured to be driven rotationally are situated on the compaction material feed device, which elements, when the collection cart is docked to the compaction material feed device, stand in, or are configured to be brought into, rotational driving engagement with the winding shaft.

42. The device as recited in claim 38, wherein a fixed upper edge of the collection cart is fashioned as a diverting element over which the one wall portion of the carrier element is diverted by 180° outward and downward, such that, when the collection cart is docked to the compaction material feed device, the free edge of the diverted wall portion of the carrier element is configured to be displaced from an initial position into a downward movement.

43. The device as recited in claim 38, wherein two fixed upper edges, situated opposite one another, of the collection cart are each configured as a diverting element over which two oppositely situated wall portions of the carrier element are each diverted outward and downward by 180°, such that, when the collection cart is docked to the compaction material feed device, the free edges of the diverted wall portions of the carrier element can each be displaced from their initial position in a synchronous or approximately synchronous movement downward.

44. The device as recited in claim 38, wherein the carrier element has, adjacent to the floor portion, four wall portions that are connected to the floor portion or are made in one piece and are not immediately connected among one another, each having a free edge, and wherein four fixed upper edges of the collection cart are each fashioned as a diverting element over which the wall portions of the carrier element are each diverted by 180° outward and downward, such that, when the collection cart is docked to the compaction material feed device, the free edges of the diverted wall portions of the carrier element are each configured to be displaced from an initial position into a synchronous or approximately synchronous movement downward.

45. The device as recited in claim 42, wherein a vertically movable lifter arm system is situated on the compaction material feed device, the lifter arm system, when the collection cart is docked to the compaction material feed device, standing in, or being configured to be brought into, moving engagement with the free edge of the diverted wall portion of the carrier element.

46. The device as recited in claim 38, wherein the carrier element is pivotably joined, at a free edge of a first wall portion, to an upper edge of the collection cart, and wherein going out from the free edge of this first wall portion, a wall portion segment whose surface corresponds substantially or approximately to a cross-sectional surface of the collection compartment of the collection cart is fashioned as a rigid surface, and wherein the carrier element is configured to be shortened or lifted from a free edge of a second wall portion situated opposite the first wall portion.

47. The device as recited in claim 46, wherein the free edge of the second wall portion of the carrier element is detachably connected to an associated upper edge of the collection cart, and wherein on the compaction material feed device there is situated a tensile device or a winding device that, when the collection cart is docked to the compaction material feed device, is configured to be brought into engagement with the free edge of the second wall portion of the carrier element, and with which the carrier element is configured to be drawn or wound upward, or can be drawn or wound downward with diversion over the upper edge of the collection cart.

48. The device as recited in claim 47, wherein the tensile device is configured as a pulley having a horizontal, vertically movable diverting roller over which the carrier element is guided, and has holding means for the detachable fixing of the free edge of the second wall portion of the carrier element.

49. The device as recited in claim 48, wherein a raised end position of the carrier element, its rigid wall portion segment substantially or approximately coincides with the cross-section of the collection compartment of the collection cart, and assumes a horizontal position or a position that is inclined upward or downward in a direction toward the compaction material feed device.

50. The device as recited in claim 38, wherein a reset device that preloads the carrier element with a force acting in a direction towards its initial position is situated on the collection cart.

51. The device as recited in claim 50, wherein in or on portions of the carrier element that, in the initial position thereof, are situated closest to lower corners of the collection cart, ballast weights are incorporated or attached, as the reset device, that bring about or support a guiding back of the carrier element into its initial position when the carrier element is lowered from a raised position.

52. The device as recited in claim 50, wherein the reset device has a tension spring system that produces the preloading force, that engages immediately or via flexible tensile means at two or more points in transition areas between the wall portions and the floor portion of the carrier element.

53. The device as recited in claim 38, wherein the carrier element is loosely suspended on a remainder of the collection cart, at least at the free edge of one of its wall portions, and wherein the compaction material feed device has a lifting arm system with which, when the collection cart is docked to the compaction material feed device, the carrier element can be grasped at its free edge remote from the compaction material feed device, and can be drawn upward by pivoting the lifting arm system in an upward direction until a shape is reached that forms a compaction material sliding surface inclined downward toward the compaction material feed device.

54. The device as recited in claim 53, wherein the compaction material feed device has a rod-shaped positioning element that, when the collection cart is docked to the compaction material feed device, runs over the upper side of the cart, and on which the carrier element can be positioned, with a bend, when it is drawn upward.

55. The device as recited in claim 38, wherein on the collection cart, at least the side walls thereof to which no wall portion of the carrier element is assigned are made with a smooth surface on the inside, or are provided with a smooth-surfaced inner cladding.

56. The device as recited in claim 38, wherein the carrier element is formed by a cloth or a fabric or a tarp or a foil or a fine-mesh net, or by a system of profile segments connected to one another in articulated fashion in a manner of roller shutters.

57. The device as recited in claim 38, wherein the free edge of a wall portion or of a plurality of wall portions, or of all wall portions of the carrier element is formed or reinforced by a respective bar-shaped or tubular profile segment connected to the carrier element.

58. A device for collecting compaction material and for supplying the collected compaction material to a press that compacts the compaction material, having a collection container that has a collection compartment for compaction material that is to be compacted, and having a compaction material feed device on which the collection container is installed in stationary fashion, the collection container having a floor as well as at least two side walls situated opposite one another, and the compaction material to be compacted being removable, by being lifted upward, from the collection container by the compaction material feed device, and being capable of being supplied to a compaction compartment or compaction material supply reservoir of the press,
wherein a web-shaped, flexible, or articulated carrier element having a floor portion and having at least two wall portions situated opposite one another, each having at least one upper, free edge, is situated on or in the collection container,
wherein, in an initial position, the carrier element lies on the floor of the collection container with a U-shape, parallel or approximately parallel to at least two oppositely situated side walls and to the floor of the collection container, or forms at least two oppositely situated side walls, and the floor, of the collection container, and
wherein, for lifting the compaction material to be compacted that is situated in the collection container, the carrier element can be shortened or lifted from the free edge of at least one of its wall portions.

59. The device as recited in claim 58,
wherein a winding shaft is situated on the free edge of one of the wall portions of the carrier element, which shaft, when the collection container is docked to the compaction material feed device, is configured to be set into a rotation that winds up the carrier element, and
wherein the collection container installed in stationary fashion on the compaction material feed device.

60. A movable collection cart for use in a device for collecting compaction material, the collection cart comprising:
a collection compartment for compaction material that is to be compacted, and being dockable to a compaction material feed device of a press,
a floor and a system of wheels on its underside, as well as at least two side walls situated opposite one another, and the compaction material to be compacted being removable, by being lifted upward, from the collection cart by the compaction material feed device and being capable of being supplied to a compaction compartment or compaction material supply reservoir of the press,
wherein a web-shaped, flexible, or articulated carrier element having a floor portion and having at least two wall portions situated opposite one another, each having at least one upper, free edge, is situated on or in the collection cart,
wherein in an initial position, the carrier element lies on the floor of the collection cart with a U-shape, parallel or approximately parallel to at least two oppositely situated side walls and to the floor of the collection cart, or forms at least two oppositely situated side walls, and the floor, of the collection cart, and
wherein for lifting the compaction material to be compacted that is situated in the collection cart, the carrier element can be shortened or lifted from the free edge of at least one of its wall portions.

61. The collection cart as recited in claim 60, wherein a winding shaft that can be set into a rotation that winds up the carrier element is situated on the free edge of one of the wall portions of the carrier element.

62. The collection cart as recited in claim 61, wherein a respective winding shaft is situated on the free edge of each of two wall portions situated opposite one another of the web-shaped carrier element, which shafts can be set into a synchronous or approximately synchronous rotation that winds up the carrier element.

63. The collection cart as recited in claim 60, wherein a fixed upper edge of the collection cart is fashioned as a diverting element over which at least one of the two wall portions of the carrier element is diverted by 180°, such that the free edge of the diverted wall portion of the carrier element can be displaced from an initial position into a downward movement.

64. The collection cart as recited in claim 60, wherein two fixed upper edges, situated opposite one another, of the collection cart are each fashioned as a diverting element over which two oppositely situated wall portions of the carrier element are each diverted by 180°, such that the free edges of the diverted wall portions of the carrier element can each be displaced in a synchronous or approximately synchronous movement downward from an initial position.

65. The collection cart as recited in claim 60, wherein the carrier element has, adjacent to the floor portion, four wall portions that are connected to the floor portion or are made in one piece and not immediately connected among one another, each having an upper free edge, and wherein four fixed upper edges of the collection cart are each fashioned as a diverting element over which the wall portions of the carrier element are each diverted by 180°, such that the free edges of the diverted wall portions of the carrier element can each be displaced from initial positions into a synchronous or approximately synchronous movement downward.

66. The collection cart as recited in claim 60, wherein the carrier element is pivotably joined, at the free edge of a first wall portion, to an upper edge of the collection cart, and that going out from the free edge of this first wall portion, a wall portion segment whose surface corresponds substantially or approximately to a cross-sectional surface of the collection compartment of the collection cart is fashioned as a rigid surface, and that the carrier element can be shortened or lifted from the free edge of a second wall portion situated opposite the first wall portion.

67. The collection cart as recited in claim 66, wherein the free edge of the second wall portion of the carrier element is detachably connected to an associated upper edge of the collection cart, and wherein by means of a tensile device or a winding device that is configured to be brought into engagement with the free edge of the second wall portion of the carrier element, the carrier element is configured to be drawn or wound upward, or is configured to be drawn or wound downward with diversion over the upper edge of the collection cart.

68. The collection cart as recited in claim 66, wherein in a raised end position of the carrier element, its rigid wall portion segment substantially or approximately coincides with a cross-section of the collection compartment of the collection cart, and assumes a substantially horizontal position or a position that is inclined upward or downward in the direction of removal of the compaction material that is to be compacted.

69. The collection cart as recited in claim 60, wherein a reset device that preloads the carrier element with a force acting in a direction towards its initial position is situated on the collection cart.

70. The collection cart as recited in claim 69, wherein in or on portions of the carrier element that, in the initial position thereof, are situated closest to lower corners of the collection cart, ballast weights are incorporated or attached, as reset device, that bring about or support a guiding back of the carrier element into its initial position when the carrier element is lowered from a raised position.

71. The collection cart as recited in claim 69, wherein the reset device has a tension spring system that produces the preloading force and that engages immediately or via flexible tensile means at two or more points in transition areas between the wall portions and the floor portion of the carrier element.

72. The collection cart as recited in claim 60, wherein on the collection cart, at least the side walls thereof to which no wall portion of the carrier element is assigned are made with a smooth surface on the inside, or are provided with a smooth-surfaced inner cladding.

73. The collection cart as recited in claim 60, wherein the carrier element is formed by a cloth or a fabric or a tarp or a foil or a fine-mesh net or by a system of profile segments connected in articulated fashion to one another as roller shutters.

74. The collection cart as recited in claim 60, wherein the free edge of a wall portion of the carrier element is formed or reinforced by a respective bar-shaped or tubular profile segment connected to the carrier element.
